(19) United States
(12) Patent Application Publication
(10) Pub. No.: US 2021/0018641 A1
(43) Pub. Date: Jan. 21, 2021

(54) DEVICE, METHOD AND SYSTEM FOR MEASURING RESISTIVITY OF OPEN HOLE FORMATION IN VERTICAL DIRECTION

(71) Applicant: Beijing Huahui Shengshi Energy Technology Co., Ltd, Shunyi District (CN)

(72) Inventor: Yongjin SHEN, Shunyi District (CN)

(21) Appl. No.: 16/568,568

(22) Filed: Sep. 12, 2019

(30) Foreign Application Priority Data
Jul. 15, 2019 (CN) 201910635103.8

(51) Int. Cl. G01V 1/50; E21B 47/14; G01V 3/30; G01V 3/34

(52) U.S. Cl. CPC G01V 1/50; G01V 3/34; G01V 3/30; E21B 47/14

(57) ABSTRACT

The present invention relates to a device, method and system for measuring a resistivity of an open hole formation in a vertical direction. The device includes an acoustic wave transmitting probe and a plurality of acoustic wave receiving probes. The acoustic wave transmitting probe is located below each of the acoustic wave receiving probes such that the acoustic wave transmitting probe and the plurality of acoustic wave receiving probes are coaxially and parallelly disposed in an open hole. The axial direction of the acoustic wave transmitting probe and the acoustic wave receiving probes is parallel to the axial direction of the open hole and is perpendicular to the direction of the formation. The measurement accuracy of the resistivity can be improved by using the device, method and system of the present invention.

### REFERENCE TO RELATED APPLICATIONS

This application claims priority to Chinese application number 201910635103.8, filed Jul. 15, 2019, with a title of DEVICE, METHOD AND SYSTEM FOR MEASURING RESISTIVITY OF OPEN HOLE FORMATION IN VERTICAL DIRECTION. The above-mentioned patent application is incorporated herein by reference in its entirety.

### TECHNICAL FIELD

The present invention relates to the field of physical parameter measurement of open hole formation in petroleum engineering logging construction, and in particular to a device, method and system for measuring a resistivity of an open hole formation in a vertical direction.

### BACKGROUND

In the oil exploration and development process, it is very important to measure the resistivity of a formation and obtain resistivity data of the open hole formation. Since the resistivity of the formation directly shows the change in oil content of the formation, the resistivity of the formation can be used to analyze whether a sandstone formation contains oil. At present, there are an induction logging method and a lateral logging method, which measure the resistivity of the formation in a circumferential direction and a radial direction, respectively. However, the accuracy of the measured resistivity is extremely low.

### SUMMARY

An objective of the present invention is to provide a device, method and system for measuring a resistivity of an open hole formation in a vertical direction, which can improve the measurement accuracy of the resistivity.

To achieve the above purpose, the present invention provides the following technical solutions.

A device for measuring the resistivity of an open hole formation in a vertical direction, having an acoustic wave transmitting probe, and a plurality N of acoustic wave receiving probes coaxially aligned with the acoustic wave transmitting probe such that the acoustic wave transmitting probe is positioned below the plurality of acoustic wave receiving probes. The acoustic wave transmitting probe and the plurality of acoustic wave receiving probes are coaxially and parallelly disposed in an open hole such that an axial direction of the acoustic wave transmitting probe and the plurality of acoustic wave receiving probes is parallel to an axial direction of the open hole and is perpendicular to a direction of the formation.

Optionally, the acoustic wave receiving probes are equidistantly distributed.

Optionally, the acoustic wave transmitting probe and the acoustic wave receiving probes are each made of a piezoelectric tube.

A method for measuring a resistivity of an open hole formation in a vertical direction includes: exciting the acoustic wave transmitting probe to obtain an electromagnetic signal; receiving the electromagnetic signal through the plurality of acoustic wave receiving probes; extracting a headmost electromagnetic signal for processing to obtain a response amplitude of the electromagnetic signal; and determining the resistivity of the open hole formation in a vertical direction according to a scaling relationship between the response amplitude and the formation resistivity.

Optionally, the extracting a headmost electromagnetic signal for processing to obtain a response amplitude of the electromagnetic signal can include: extracting a headmost electromagnetic signal for fast Fourier transform (FFT) processing to obtain a frequency spectrum of the electromagnetic signal; and extracting the frequency spectrum to obtain a response amplitude.

Optionally, the exciting an acoustic wave transmitting probe to obtain an electromagnetic signal specifically includes exciting an acoustic wave transmitting probe in a transient excitation mode to obtain an electromagnetic signal.

A system for measuring a resistivity of an open hole formation in a vertical direction includes: an excitation module configured to excite an acoustic wave transmitting probe to obtain an electromagnetic signal; a receiving module configured to receive the electromagnetic signal through a plurality of acoustic wave receiving probes; a response amplitude determining module configured to extract a headmost electromagnetic signal for processing to obtain a response amplitude of the electromagnetic signal; and a resistivity determining module configured to determine the resistivity of the open hole formation in a vertical direction according to a scaling relationship between the response amplitude and the formation resistivity.

Optionally, the response amplitude determining module specifically includes: a Fourier transform processing unit, configured to extract a headmost electromagnetic signal for fast Fourier transform processing to obtain a frequency spectrum of the electromagnetic signal; and a response amplitude determining unit, configured to extract the frequency spectrum to obtain a response amplitude.

Optionally, the excitation module specifically includes an excitation unit, configured to excite an acoustic wave transmitting probe in a transient excitation mode to obtain an electromagnetic signal.

According to a specific embodiment provided by the present invention, the present invention discloses the following technical effects: the present invention provides a device for measuring a resistivity of an open hole formation in a vertical direction, including: an acoustic wave transmitting probe and acoustic wave receiving probes, where the number of the acoustic wave receiving probes is N, and the acoustic wave transmitting probe is located below each of the acoustic wave receiving probes; the acoustic wave transmitting probe and the acoustic wave receiving probes are coaxially parallelly disposed in an open hole, and the axial direction of the acoustic wave transmitting probe and the acoustic wave receiving probes is parallel to the axial direction of the open hole and is perpendicular to the direction of the formation. In the open hole, by measuring the electromagnetic response waveform generated by the acoustic wave transmitting probe during vibration, the resistivity of the formation in the vertical direction is measured (without affecting the measurement of acoustic parameters), the accuracy of the resistivity measurement is improved, and new resistivity data is added for the evaluation of the formation, which is favorable for evaluating the anisotropy of the formation.

### BRIEF DESCRIPTION OF THE DRAWINGS

To describe the technical solutions in the embodiments of the present invention or in the prior art more clearly, the following briefly describes the accompanying drawings required for describing the embodiments. The accompanying drawings in the following description show some embodiments of the present invention, and a person of ordinary skill in the art may still derive other drawings from these accompanying drawings without creative efforts.

FIG. 1 is a schematic view showing the composition of a device for measuring a resistivity of an open hole formation in a vertical direction according to an embodiment of the invention;

FIG. 2 is a flow chart of a method for measuring a resistivity of an open hole formation in a vertical direction according to an embodiment of the invention;

FIG. 3 is a structural view of a system for measuring a resistivity of an open hole formation in a vertical direction according to an embodiment of the invention;

FIG. 4 is a graphical representation of an electromagnetic response waveform and an acoustic waveform;

FIG. 5 is a graphical representation of waveforms of electric field strength at different source distances;

FIG. 6 is a graphical representation of an electric field strength waveform at a source distance of 1.2 m;

FIG. 7 is a graphical representation of an electric field strength waveform at a source distance of 2.0 m;

FIG. 8 is a graphical representation showing a change of a maximum electric field strength with the formation resistivity at a source distance of 1.2 m; and

FIG. 9 is a graphical representation showing a change of a maximum electric field strength with the formation resistivity at a source distance of 2.0 m.

### DETAILED DESCRIPTION

The following clearly and completely describes the technical solutions in the embodiments of the present invention with reference to the accompanying drawings in the embodiments of the present invention. The described embodiments are merely a part rather than all of the embodiments of the present invention. All other embodiments obtained by a person of ordinary skill in the art based on the embodiments of the present invention without creative efforts shall fall within the protection scope of the present invention.

An objective of the present invention is to provide a device, method and system for measuring a resistivity of an open hole formation in a vertical direction, which can improve the measurement accuracy of the resistivity.

To make the foregoing objective, features, and advantages of the present invention clearer and more comprehensible, the present invention is further described in detail below with reference to the accompanying drawings and specific embodiments.

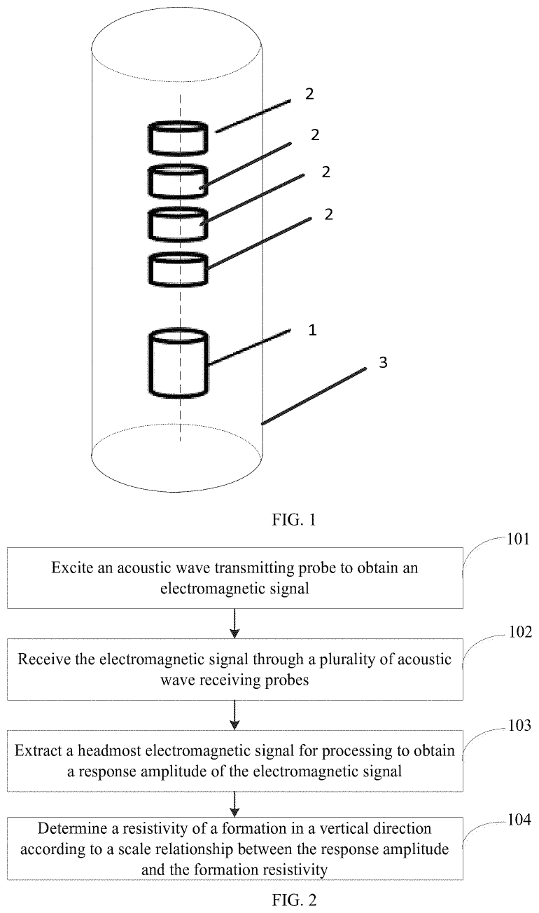

FIG. 1 is a schematic view showing the composition of a device for measuring a resistivity of an open hole formation in a vertical direction according to embodiment of the present invention. As shown in FIG. 1, the device for measuring a resistivity of an open hole formation in a vertical direction includes: an acoustic wave transmitting probe 1 and acoustic wave receiving probes 2, where the number of the acoustic wave receiving probes 2 is N. The acoustic wave transmitting probe 1 is located below each of the acoustic wave receiving probes 2, and the acoustic wave transmitting probe 1 and the acoustic wave receiving probes 2 are coaxially and parallelly disposed with respect to each other in an open hole. The axial direction of the acoustic wave transmitting probe 1 and the acoustic wave receiving probes 2 is parallel to the axial direction of the open hole 3 and is perpendicular to the direction of the formation. The acoustic wave receiving probes 2 are equidistantly distributed. The acoustic wave transmitting probe 1 and the acoustic wave receiving probes 2 are each made of a piezoelectric tube.

FIG. 2 is a flow chart of a method for measuring a resistivity of an open hole formation in a vertical direction according to an embodiment of the present invention. As shown in FIG. 2, the method for measuring a resistivity of an open hole formation in a vertical direction includes the following steps.

Step 101: exciting an acoustic wave transmitting probe to obtain an electromagnetic signal. This can include exciting the acoustic wave transmitting probe in a transient excitation mode to obtain an electromagnetic signal. The transient electromagnetic signal is generated while vibration is generated. The transient electromagnetic signal and an acoustic signal propagate simultaneously in a well. The electromagnetic signal propagates fast and is located at the front of a received waveform (near an excitation moment), and the acoustic signal propagates slowly. After a period of time, the acoustic signal is separated from the electromagnetic signal.

The formation resistivity of different frequency intervals can be obtained by changing the excitation waveform and exciting with a different on-time to repeat the above-mentioned formation resistivity generation process. Since the on-time is different, excited main frequencies are different, so that the formation resistivity at different frequencies is obtained.

Step 102: receive the electromagnetic signal through a plurality of acoustic wave receiving probes. Each of the acoustic wave receiving probes coaxially mounted with the acoustic wave transmitting probe and separated by a distance receives both the acoustic signal and the electromagnetic signal. The propagation time of the electromagnetic signal is short and the phase change is not obvious. The acoustic signal has a longer propagation time, a significant phase change, and a large delay. There is no overlap between the two. Only the electromagnetic signal is considered in this embodiment.

Step 103: extracting a headmost electromagnetic signal for processing to obtain a response amplitude of the electromagnetic signal. This can include extracting a headmost electromagnetic signal for fast Fourier transform processing to obtain a frequency spectrum of the electromagnetic signal; and extracting the frequency spectrum to obtain a response amplitude.

Step 104: determining a resistivity of a formation in a vertical direction according to a scaling relationship between the response amplitude and the formation resistivity. More specifically, the following situations are included during the processing:

For the waveform at each source distance, the formation resistivity is indicated by the amplitude (maximum amplitude) of the first peak in the headmost waveform. The resistivity of the formation in the vertical direction is obtained by scaling. The resistivity is a resistivity corresponding to the main frequency of an excitation probe.

For waveforms at different source distances, the response waveform of the electric field strength is obtained by subtracting the waveform at an adjacent source distance, and the maximum value is taken as the measured value. By scaling according to the measured value, the resistivity of the formation in the vertical direction is obtained. The resistivity is obtained by response subtraction (a difference method), which removes direct coupling responses (common to all source distances) in the responses, and the resolution of the formation in the vertical direction of is relatively high.

The electromagnetic signal in front of the waveform is subjected to fast Fourier transform processing, and the resistivity of the formation is indicated by using a maximum of the frequency spectrum and the resistivity of the formation in a z direction is obtained by scaling. The resistivity contains all main frequency components in the response waveform, regardless of the time at which the response is distributed over the waveform.

The electromagnetic signal in front of the waveform is subjected to fast Fourier transform processing, and the area of the frequency spectrum is taken as the measured value, and the resistivity of the formation in the z direction is obtained by scaling. This resistivity contains all frequency components and is a comprehensive resistivity value.

The measured transient waveform contains continuous frequency components, and the amplitude corresponding to each frequency is proportional to the resistivity of the formation. In this way, the frequency spectrum of the excitation acoustic waveform is removed using a deconvolution method, and the resistivity value of the continuous frequency can be obtained, and a curve of change of the formation resistivity with frequency is obtained.

FIG. 3 is a structural view of a system for measuring a resistivity of an open hole formation in a vertical direction according to the present invention; As shown in FIG. 3, the system for measuring a resistivity of an open hole formation in a vertical direction includes an excitation module 201 configured to excite an acoustic wave transmitting probe to obtain an electromagnetic signal. A receiving module 202 is configured to receive the electromagnetic signal through a plurality of acoustic wave receiving probes. A response amplitude determining module 203 is configured to extract a headmost electromagnetic signal for processing to obtain a response amplitude of the electromagnetic signal, and a resistivity determining module 204 is configured to determine a resistivity of a formation in a vertical direction according to a scaling relationship between the response amplitude and the formation resistivity.

The response amplitude determining module 203 can specifically include a Fourier transform processing unit configured to extract a headmost electromagnetic signal for fast Fourier transform processing to obtain a frequency spectrum of the electromagnetic signal. And a response amplitude determining unit configured to extract the frequency spectrum to obtain a response amplitude.

The excitation module 201 can include an excitation unit that configured to excite an acoustic wave transmitting probe in a transient excitation mode to obtain an electromagnetic signal.

The present invention has the following advantages:

1. The formation resistivity measurement and acoustic wave parameter measurement of the formation in the vertical direction are carried out simultaneously under the same conditions. The identical excitation probe is used and the same receiving probes are used for receiving. This is conducive to the complementing of acoustic and electrical measurement methods, automatically achieves instrument integration, and facilitates the shortening of the length of an instrument, thereby improving the accurate measurement of the resistivity.

2. The measured transient waveform contains continuous frequency components, and the amplitude corresponding to each frequency is proportional to the resistivity of the formation. In this way, the frequency spectrum of the excitation waveform is removed, the resistivity value of the continuous frequency can be obtained, and a curve of change of the formation resistivity with frequency is obtained. The resistivity measurement is changed from one value to a curve. The amount of raw measurement information has been greatly increased.

### EMBODIMENT 1

The present invention is based on a numerical calculation result of a rigorous solution of a transient electromagnetic field excited by an acoustic logging probe in an open hole. An electric field strength in the open hole in the z direction is proportional to a resistivity of a formation. The physical mechanism is that the z direction in a well (or hole) is parallel to a well wall, and the electric field strength in the z direction is a tangential component with respect to the well wall, and is continuous with the electric field strength in the formation in the z direction at the well wall. In the formation, the electric field strength in the z direction is perpendicular to a horizontal stratified interface of the formation. The current density is continuous at the horizontal stratified interface, and the discontinuous electric field strength is related to the resistivity of the formation. Therefore, the electric field strength in the well (or hole) in the z direction carries formation resistivity information. When the source distance is relatively short, the influence of the well is relatively small, and the waveform amplitude of the transient electromagnetic response excited by the acoustic probe is proportional to the resistivity of the formation, and when the source distance is lengthened, the two are approximately proportional. A measured physical quantity is Ez, the obtained resistivity is the resistivity of the formation in the z direction. The z direction referred to in the present invention means a direction perpendicular to the formation.

By using this theoretical research result, the present invention provides a novel method for resistivity logging of an open hole formation in a z direction. The following technical solution is adopted:

The method for resistivity logging of an open hole formation in a z direction is used for measuring a resistivity of an open hole formation in a vertical direction. The method includes the following steps:
Step 1): coaxially mount an acoustic wave transmitting probe and a receiving probe array (receiving probes at different source distances) made of piezoelectric tubes together to form a probe structure, and place the probe structure in an open hole. The transmitting probe is excited by a transient excitation mode to generate vibration of the probe at a natural frequency, and at the same time a transient electromagnetic signal is generated. The transient electromagnetic signal and a vibration (acoustic) signal propagate simultaneously in a well. The electromagnetic signal has a fast propagation speed and is located at the front of a received waveform (at an excitation moment), and the acoustic signal has a slow propagation speed. After a period of time, the acoustic signal is separated from the electromagnetic signal.
Step 2): receive both the acoustic signal and an electromagnetic response signal by each of the receiving probes coaxially mounted with the transmitting probe and separated by a distance. The propagation time of the electromagnetic response waveform is short and the phase change is not obvious. The acoustic signal has a longer propagation time, a significant phase change, and a large delay. There is no overlap between the two. The headmost electromagnetic signal is extracted for processing.
Step 3): for the waveform at each source distance, extract the amplitude (maximum amplitude) of a first peak in the headmost waveform to indicate the formation resistivity, establish a scaling method by a linear relationship which exists between the response amplitude obtained by theoretical response and the formation resistivity, and convert the amplitude into the resistivity of the formation in the z direction. The same processing is performed on the waveform of each depth point to obtain a resistivity curve. The resistivity is a resistivity corresponding to the main frequency of an excitation probe.
Step 4): for waveforms at different source distances, obtain a response waveform of the electric field strength in the z direction by subtracting the waveform at an adjacent source distance, obtain a maximum value as the measured value, establish a scaling method by utilizing the linear relationship between the electric field strength of the well in the z direction and the resistivity of the formation, convert the measured value into the resistivity of the formation, and obtain the resistivity of the formation in the vertical direction according to the scale of the measured value. The resistivity is obtained by response subtraction (a difference method), which removes direct coupling responses (common to all source distances) in the responses, and the resolution of the formation in the z direction is relatively high.
Step 5): extract the electromagnetic signal in front of the waveform to form a sequence, perform FFT on the sequence to obtain a frequency spectrum thereof, use the maximum value of the amplitude spectrum as the measured value to indicate the formation resistivity, establish a scaling method by means of the linear relationship between the acquired response amplitude and the formation resistivity, convert the measured value into the resistivity of the formation, and obtain the resistivity of the formation in the z direction by scaling. The resistivity contains all main frequency components in the response waveform, regardless of the time at which the response is distributed over the waveform.
Step 6): extract the electromagnetic response signal in front of the waveform to obtain a time-varying sequence, perform FFT on the sequence to obtain the spectrum, take the amplitude spectrum of the frequency spectrum, and take the area enclosed by the amplitude spectrum as the measured value; where the measured value is a superposition of the amplitudes of all frequencies in the measured waveform and contains the contribution of all frequency components to the measured values. Similarly, the scaling method is established by means of the linear relationship between the acquired response amplitude and the formation resistivity, and the measured value is converted into the resistivity of the formation, that is, the measured value is scaled to obtain the resistivity of the formation in the z direction. This resistivity is a resistivity value that synthesizes all frequencies.
Step 7): change the period of the excitation waveform by adjusting the on-time, that is, excite with different on-time, and repeat the above-mentioned formation resistivity generation process to measure the formation resistivity of different frequency intervals (determined by on-time and off-time). Since the on-time is different, excited main frequencies are different, so that the formation resistivity at different frequencies is obtained.
Step 8): the waveform measured in the present invention is transient; the transient waveform contains a continuous frequency component of a frequency segment, and each frequency corresponds to an amplitude which is proportional to the resistivity of the formation. Different frequencies have different amplitudes of response, the frequency spectrum of the excitation waveform is removed by using a deconvolution method, and the response amplitude value of each continuous frequency can be obtained. The scaling method is established by means of a linear relationship between the obtained response amplitude and the formation resistivity. The measured value of each frequency is converted into the resistivity of the formation, and the resistivity value of the formation in the z direction corresponding to these frequencies and a curve of change of the formation resistivity with frequency are obtained.

### EMBODIMENT 2

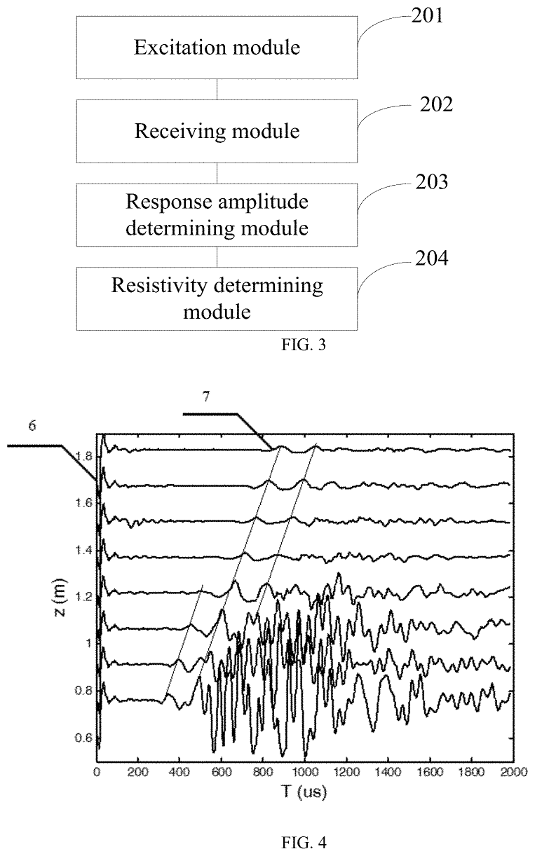

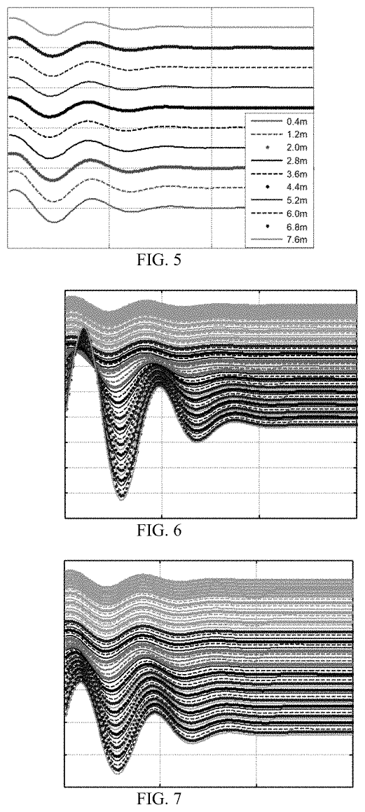

The present invention provides a logging method for measuring a formation resistivity by using an open hole acoustic logging probe, including the following steps:
Step 1): excite vibration by an acoustic wave transmitting probe 1 made of a piezoelectric tube in an open hole while generating a transient electromagnetic field. The frequency spectrum of the acoustic wave transmitting probe is consistent with the frequency spectrum of acoustic vibration. An electromagnetic response is generated in the open hole and the formation, and array acoustic wave probes 2 at different source distances can receive the transient response waveform. The waveform shape obtained by theoretical simulation is shown in FIG. 4. FIG. 4 is a schematic view of an electromagnetic response waveform and an acoustic waveform, where an electromagnetic response waveform 6 and an acoustic waveform 7 are provided.
Step 2): take a maximum value from each measured response waveform.
Step 3): for each maximum value, obtain the resistivity value by scaling in accordance with the proportional relationship between the response peak and the resistivity of the formation. This is the most direct measured value of the resistivity measurement that reflects the (z-direction) resistivity of the main frequency of the excitation probe. FIG. 5 is a graphical representation of waveforms of electric field strength at different source distances. When the conductivity of the formation is equal to 5 S/m, for the electromagnetic response waveforms in the open hole at different source distances, the amplitude decreases with the increase of the source distance, and the response shape of the electric field strength Ez does not change.
Step 4): process the response waveforms at different source distances, obtain the response difference by subtracting the waveform at an adjacent source distance, and the response difference is proportional to the electric field strength Ez in the z direction; take the maximum value as the measured value, and obtain the resistivity of the formation in the vertical direction by scaling according to the measured value. The resistivity is obtained by response subtraction (a difference method), which removes direct coupling responses (common to all source distances) in the responses, and the resolution of the formation in the z direction is relatively high. FIG. 6 is a schematic view of an electric field strength waveform at a source distance of 1.2 m; and FIG. 7 is a schematic view of an electric field strength waveform at a source distance of 2.0 m. Each of the curves in graphs of FIG. 6 and FIG. 7 represent a formation conductivity, and the formation conductivities are sequentially 1/15, 1/14, 1/13, 1/12, . . . 1/2, 1, 2, 3, . . . , 25 S/m from bottom to top. There are a total of 39 response curves.

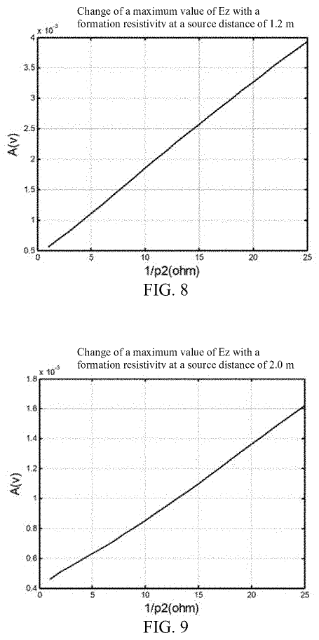

FIG. 8 is a graphical representation showing a change of a maximum electric field strength with the formation resistivity at a source distance of 1.2 m; and FIG. 9 is a graphical representation showing a change of a maximum electric field strength with the formation resistivity at a source distance of 2.0 m. When the source distance is less than 1.2 m, the response waveform is a straight line. When the source distance is more than 2 m, the straight line has a certain curvature, which is the influence of the existence of the open hole.
Step 5): perform FFT on the response waveform to obtain a frequency spectrum, where the amplitude of each frequency corresponds to a resistivity value, and the maximum value is scaled to obtain the resistivity of the formation in the z direction. The resistivity is a synthesis of responses at all times in the waveform.
Step 6): perform FFT on the electromagnetic response signal, take the area of the frequency spectrum as the measured value, and obtain the resistivity of the formation in the z direction by scaling the measured value. This resistivity contains all frequency components and is a resistivity value that synthesizes the frequencies.
Step 7): change the excitation waveform and excite with different on-time to repeat the above-mentioned formation resistivity generation process to obtain the formation resistivity of different frequency intervals. Since the on-time is different, excited main frequencies are different, so that the formation resistivity of different frequency intervals is obtained.
Step 8): the measured transient waveform contains continuous frequency components, and the amplitude corresponding to each frequency is proportional to the resistivity of the formation. In this way, the frequency spectrum of the excitation waveform is removed using a deconvolution method, the resistivity value of the continuous frequency can be obtained, and a curve of change of the formation resistivity with frequency is obtained.

The key to the present invention is to theoretically find that the electric field strength Ez of the transient electromagnetic response of the open hole during the excitation of the acoustic probe is linearly related to the resistivity of the formation. Based on this, a new transient waveform acquisition method is designed, and the electromagnetic response and acoustic logging response waveforms are completely recorded. The transient electromagnetic response waveform is processed in the time domain and the frequency domain to obtain a measured value for indicating the formation resistivity, which becomes the resistivity of the formation in the vertical direction after being scaled.

Each embodiment of the present specification is described in a progressive manner, each embodiment focuses on the difference from other embodiments, and the same and similar parts between the embodiments may refer to each other. For a system disclosed in the embodiments, since it corresponds to the method disclosed in the embodiments, the description is relatively simple, and reference can be made to the method description.

Several examples are used for illustration of the principles and implementation methods of the present invention. The description of the embodiments is used to help illustrate the method and its core principles of the present invention. In addition, those skilled in the art can make various modifications in terms of specific embodiments and scope of application in accordance with the teachings of the present invention. In conclusion, the content of this specification shall not be construed as a limitation to the present invention.

What is claimed is:

1. A device for measuring the resistivity of an open hole formation in a vertical direction, comprising:
an acoustic wave transmitting probe; and
a plurality N of acoustic wave receiving probes coaxially aligned with the acoustic wave transmitting probe such that the acoustic wave transmitting probe is positioned below the plurality of acoustic wave receiving probes,
the acoustic wave transmitting probe and the plurality of acoustic wave receiving probes being coaxially parallelly disposed in an open hole such that an axial direction of the acoustic wave transmitting probe and the plurality of acoustic wave receiving probes is parallel to an axial direction of the open hole and is perpendicular to a direction of the formation.

2. The device for measuring a resistivity of an open hole formation in a vertical direction according to claim 1, wherein the acoustic plurality of wave receiving probes are equidistantly distributed.

3. The device for measuring a resistivity of an open hole formation in a vertical direction according to claim 1, wherein the acoustic wave transmitting probe and the plurality of acoustic wave receiving probes are each made of a piezoelectric tube.

4. A method for measuring the resistivity of an open hole formation in a vertical direction, wherein the method is applied to the device for measuring a resistivity of an open hole formation in a vertical direction according to claim 1, the method comprising:
exciting the acoustic wave transmitting probe to obtain an electromagnetic signal;
receiving the electromagnetic signal through the plurality of acoustic wave receiving probes;
extracting a headmost electromagnetic signal for processing to obtain a response amplitude of the electromagnetic signal; and
determining the resistivity of the open hole formation in a vertical direction according to a scaling relationship between the response amplitude and the formation resistivity.

5. A method for measuring the resistivity of an open hole formation in a vertical direction, wherein the method is applied to the device for measuring a resistivity of an open hole formation in a vertical direction according to claim 2, the method comprising:
exciting the acoustic wave transmitting probe to obtain an electromagnetic signal;
receiving the electromagnetic signal through the plurality of acoustic wave receiving probes;
extracting a headmost electromagnetic signal for processing to obtain a response amplitude of the electromagnetic signal; and
determining the resistivity of the open hole formation in a vertical direction according to a scaling relationship between the response amplitude and the formation resistivity.

6. A method for measuring the resistivity of an open hole formation in a vertical direction, wherein the method is applied to the device for measuring a resistivity of an open hole formation in a vertical direction according to claim 3, the method comprising:
exciting the acoustic wave transmitting probe to obtain an electromagnetic signal;
receiving the electromagnetic signal through the plurality of acoustic wave receiving probes;
extracting a headmost electromagnetic signal for processing to obtain a response amplitude of the electromagnetic signal; and
determining a resistivity of the open hole formation in a vertical direction according to a scaling relationship between the response amplitude and the formation resistivity.

7. The method for measuring the resistivity of an open hole formation in a vertical direction according to claim 4, wherein the extracting a headmost electromagnetic signal for processing to obtain a response amplitude of the electromagnetic signal comprises:
extracting a headmost electromagnetic signal for fast Fourier transform processing to obtain a frequency spectrum of the electromagnetic signal; and
extracting the frequency spectrum to obtain a response amplitude.

8. The method for measuring the resistivity of an open hole formation in a vertical direction according to claim 5, wherein the extracting a headmost electromagnetic signal for processing to obtain a response amplitude of the electromagnetic signal comprises:
extracting a headmost electromagnetic signal for fast Fourier transform processing to obtain a frequency spectrum of the electromagnetic signal; and
extracting the frequency spectrum to obtain a response amplitude.

9. The method for measuring the resistivity of an open hole formation in a vertical direction according to claim 6, wherein the extracting a headmost electromagnetic signal for processing to obtain a response amplitude of the electromagnetic signal comprises:
extracting a headmost electromagnetic signal for fast Fourier transform processing to obtain a frequency spectrum of the electromagnetic signal; and
extracting the frequency spectrum to obtain a response amplitude.

10. The method for measuring the resistivity of an open hole formation in a vertical direction according to claim 4, wherein the exciting an acoustic wave transmitting probe to obtain an electromagnetic signal comprises:
exciting the acoustic wave transmitting probe in a transient excitation mode to obtain an electromagnetic signal.

11. The method for measuring a resistivity of an open hole formation in a vertical direction according to claim 5, wherein the exciting an acoustic wave transmitting probe to obtain an electromagnetic signal comprises:
exciting the acoustic wave transmitting probe in a transient excitation mode to obtain an electromagnetic signal.

12. The method for measuring a resistivity of an open hole formation in a vertical direction according to claim 6, wherein the exciting an acoustic wave transmitting probe to obtain an electromagnetic signal comprises:
exciting the acoustic wave transmitting probe in a transient excitation mode to obtain an electromagnetic signal.

13. A system for measuring the resistivity of an open hole formation in a vertical direction, comprising:
an excitation module, configured to excite an acoustic wave transmitting probe to obtain an electromagnetic signal;
a receiving module, configured to receive the electromagnetic signal through a plurality of acoustic wave receiving probes;
a response amplitude determining module, configured to extract a headmost electromagnetic signal for processing to obtain a response amplitude of the electromagnetic signal; and
a resistivity determining module, configured to determine the resistivity of the open hole formation in a vertical direction according to a scaling relationship between the response amplitude and the formation resistivity.

14. The system for measuring a resistivity of an open hole formation in a vertical direction according to claim 13, wherein the response amplitude determining module specifically comprises:
a Fourier transform processing unit, configured to extract a headmost electromagnetic signal for fast Fourier transform processing to obtain a frequency spectrum of the electromagnetic signal; and
a response amplitude determining unit, configured to extract the frequency spectrum to obtain a response amplitude.

15. The system for measuring the resistivity of an open hole formation in a vertical direction according to claim 13, wherein the excitation module specifically comprises:
an excitation unit configured to excite the acoustic wave transmitting probe in a transient excitation mode to obtain an electromagnetic signal.
